(19) United States
(12) Patent Application Publication
(10) Pub. No.: US 2023/0378498 A1
(43) Pub. Date: Nov. 23, 2023

(54) FUEL CELL SYSTEM

(71) Applicant: TOYOTA JIDOSHA KABUSHIKI KAISHA, Toyota-shi (JP)

(72) Inventor: Masaaki MATSUSUE, Mishima-shi (JP)

(73) Assignee: TOYOTA JIDOSHA KABUSHIKI KAISHA, Toyota-shi (JP)

(21) Appl. No.: 18/309,479

(22) Filed: Apr. 28, 2023

(30) Foreign Application Priority Data
May 17, 2022 (JP) 2022-081046

(51) Int. Cl. H01M 8/04701; H01M 8/04014; H01M 8/0432; H01M 8/04746

(52) U.S. Cl. CPC H01M 8/04701; H01M 8/04014; H01M 8/0432; H01M 8/04753; H01M 2008/1095

(57) ABSTRACT

A fuel cell system includes a fuel cell, a fuel gas supply device, an oxidant gas supply device, a refrigerant supply device, a fuel cell temperature measurement device configured to measure a temperature of the fuel cell, and a control unit. The control unit is configured to, when the temperature of the fuel cell is lower than a target temperature, perform a warm-up operation to increase the temperature of the fuel cell to the target temperature by generating the electric power with the fuel cell while cooling the fuel cell with the oxidant gas by stopping supply of the refrigerant and controlling an amount of the oxidant gas supplied.

### CROSS-REFERENCE TO RELATED APPLICATION

This application claims priority to Japanese Patent Application No. 2022-081046 filed on May 17, 2022, incorporated herein by reference in its entirety.

### BACKGROUND

### 1. Technical Field

The disclosure relates to a fuel cell system.

### 2. Description of Related Art

A fuel cell system is a power generation apparatus that supplies oxidant gas and fuel gas to a fuel cell to generate electric power. A fuel cell usually generates electric power at a predetermined target temperature to increase electrical efficiency. Therefore, when a fuel cell is started at a low temperature, the temperature of the fuel cell needs to be rapidly increased to a target temperature. Such a process is called a warm-up operation. A warm-up operation is performed by generating electric power with a fuel cell.

A method of warming up a fuel cell system at a low-temperature startup is described in, for example, Japanese Unexamined Patent Application Publication No. 2015-216084 (JP 2015-216084 A) and Japanese Unexamined Patent Application Publication No. 2010-186599 (JP 2010-186599 A). In JP 2015-216084 A and JP 2010-186599 A, the rate of increase in temperature is increased by adjusting the amount of refrigerant supplied to flow through a fuel cell stack.

### SUMMARY

In warm-up operation, it is conceivable that refrigerant is not supplied to a fuel cell at all to increase the rate of increase in the temperature of the fuel cell. However, if refrigerant is not supplied at all, heat spots occur in the fuel cell, so the degradation of the fuel cell can be facilitated.

On the other hand, when the amount of refrigerant supplied is adjusted as described in JP 2015-216084 A and JP 2010-186599 A, occurrence of heat spots is suppressed to some extent. However, a valve or the like needs to be installed in a refrigerant flow channel, which may lead to a complicated system and a cost increase.

The disclosure provides a fuel cell system capable of suppressing heat spots while performing a warm-up operation with a simple structure.

An aspect of the disclosure provides a fuel cell system. The fuel cell system includes a fuel cell configured to generate electric power when supplied with fuel gas and oxidant gas, a fuel gas supply device configured to supply the fuel gas to the fuel cell, an oxidant gas supply device configured to supply the oxidant gas to the fuel cell, a refrigerant supply device configured to supply refrigerant to the fuel cell, a fuel cell temperature measurement device configured to measure a temperature of the fuel cell, and a control unit. The control unit is configured to, when the temperature of the fuel cell is lower than a target temperature, perform a warm-up operation to increase the temperature of the fuel cell to the target temperature by generating the electric power with the fuel cell while cooling the fuel cell with the oxidant gas by stopping supply of the refrigerant and controlling an amount of the oxidant gas supplied.

In the fuel cell system, the refrigerant may be a coolant gas.

In the fuel cell system, the control unit may be configured to control the oxidant gas supply device such that the amount of the oxidant gas supplied during the warm-up operation is greater than or equal to a half and less than or equal to ten times the amount of the oxidant gas supplied during normal operation.

In the fuel cell system, the control unit may be configured to control the fuel gas supply device such that an amount of the fuel gas supplied during the warm-up operation is greater than or equal to twice and less than or equal to ten times the amount of the fuel gas supplied during normal operation.

With the fuel cell system according to the aspect of the disclosure, heat spots are suppressed while a warm-up operation is performed with a simple configuration.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram of a fuel cell system;

FIG. 2 is an example of a flowchart of warm-up operation control; and

FIG. 3 is a block diagram of a fuel cell system.

### DETAILED DESCRIPTION OF EMBODIMENTS

### Fuel Cell System 100

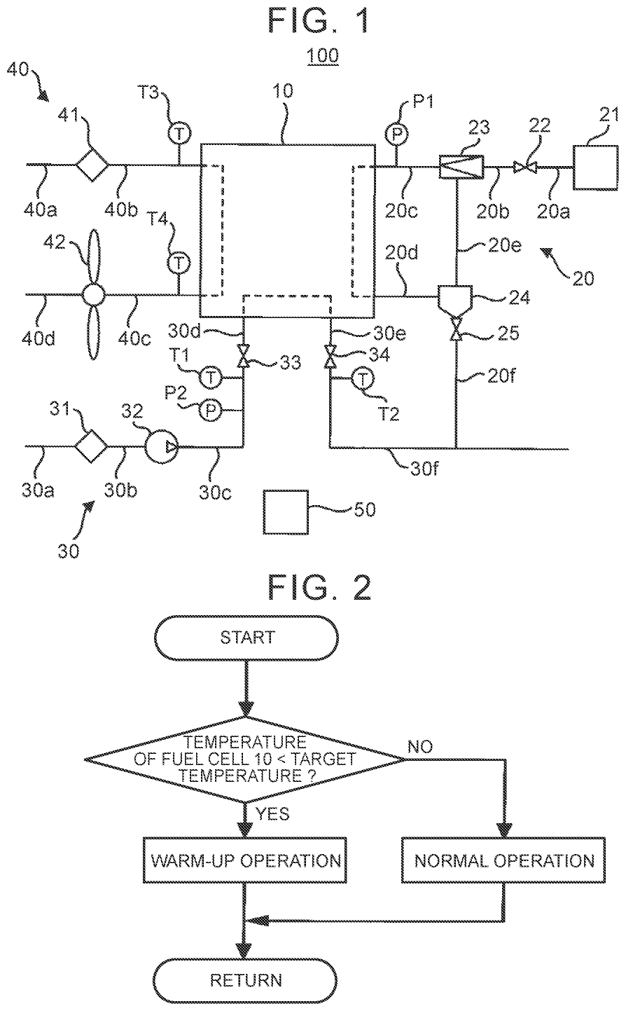

A fuel cell system according to an aspect of the disclosure will be described in detail by using a fuel cell system 100 that is one embodiment. FIG. 1 is a block diagram of the fuel cell system 100.

As shown in FIG. 1, the fuel cell system 100 includes a fuel cell 10, a fuel gas piping section 20, an oxidant gas piping section 30, a refrigerant piping section 40, and a control unit 50.

### Fuel Cell 10

The fuel cell 10 is made up of a plurality of single cells stacked in series. Each of the single cells has an electrolyte membrane, an anode disposed on one surface of the electrolyte membrane, and a cathode disposed on the other surface of the electrolyte membrane. Specifically, a catalyst layer is disposed on each surface of the electrolyte membrane, a gas diffusion layer is disposed on the outer side of each catalyst layer, and a separator having a fuel gas flow channel and an oxidant gas flow channel is disposed on the outer side of each gas diffusion layer. The configuration of each of the above single cells is a general configuration. In each single cell, the set of catalyst layer and gas diffusion layer functions as an anode or a cathode.

The electrolyte membrane, the catalyst layers, the gas diffusion layers, and the separators, disposed in each single cell, are not limited and may be known ones. Examples of the electrolyte membrane include an ion exchange membrane made of a solid polymer material. Examples of the catalyst layer include a platinum catalyst. Examples of the gas diffusion layer include porous materials, such as carbon materials. Examples of the separator include metal materials, such as stainless steels, and carbon materials, such as carbon composite materials.

The fuel cell 10 generates electric power through electrochemical reaction when fuel gas is supplied to the anode and oxidant gas is supplied to the cathode. When, for example, a vehicle is equipped with the fuel cell system 100, the generated current is used by an electrical load provided in the vehicle or stored in a battery.

The fuel cell 10 having a size and capacity with which occurrence of heat spots is suppressed by cooling with oxidant gas during warm-up operation may be selected.

### Fuel Gas Piping Section 20

The fuel gas piping section 20 is to supply the anode of the fuel cell 10 with fuel gas. The fuel gas piping section 20 includes a fuel gas supply source 21, an injector 22, an ejector 23, a gas-liquid separator 24, and an exhaust and drain valve 25. The fuel gas piping section 20 includes flow channels 20a, 20b, 20c, 20d, 20e, 20f that are pipes connected to these members. The fuel gas piping section 20 further includes a fuel gas pressure measurement device P1 at a fuel gas inlet side of the fuel cell 10. The fuel gas piping section 20 may further include members generally included in a fuel gas piping section.

The fuel gas supply source 21 may be made up of a high-pressure hydrogen tank, a hydrogen storing alloy, and the like that store hydrogen gas. Alternatively, the fuel gas supply source 21 may be made up of a reformer and a high-pressure gas tank. The reformer produces hydrogen-rich reformed gas from hydrocarbon fuel, and a high-pressure gas tank that brings reformed gas produced by the reformer into a high-pressure state and accumulates the reformed gas. Therefore, the fuel gas is a hydrogen gas or a reformed gas.

The flow channel 20a is a pipe that connects the fuel gas supply source 21 with the injector 22. The flow channel 20a functions to feed fuel gas, supplied from the fuel gas supply source 21, to the injector 22. A shutoff valve that controls the open and closed states of the fuel gas supply source 21 and a regulator that controls the pressure of fuel gas may be provided in the flow channel 20a.

The injector 22 is a fuel gas supply device that supplies fuel gas to the fuel cell 10. The injector 22 is capable of controlling the amount of fuel gas supplied to the fuel cell 10. The amount of fuel gas supplied from the injector 22 is controlled by the control unit 50. Examples of the injector 22 include an on-off valve and a solenoid valve.

The flow channel 20b is a pipe that connects the injector 22 with the ejector 23. The flow channel 20b functions to feed fuel gas, supplied from the injector 22, to the ejector 23.

The ejector 23 functions to supply the fuel cell 10 with fuel gas supplied from the injector 22. The ejector 23 functions to supply the fuel cell 10 with circulating gas separated by the gas-liquid separator 24. The ejector 23 functions to supply the fuel cell 10 with mixed gas obtained by mixing fuel gas supplied from the injector 22 with circulating gas separated by the gas-liquid separator 24. The ejector 23 is known.

The flow channel 20c (fuel gas supply flow channel) is a pipe that connects the fuel cell 10 with the ejector 23. The flow channel 20c functions to feed fuel gas, supplied from the ejector 23, to the fuel cell 10.

The fuel gas pressure measurement device P1 is disposed in the flow channel 20c. The fuel gas pressure measurement device P1 measures the pressure of fuel gas supplied to the fuel cell 10. A measured result is transmitted to the control unit 50.

The flow channel 20d (fuel gas exhaust flow channel) is a pipe that connects the fuel cell 10 with the gas-liquid separator 24. The flow channel 20d functions to feed fuel gas (fuel off-gas), exhausted from the fuel cell 10, to the gas-liquid separator 24. Liquid water produced by the electrochemical reaction in the fuel cell 10 is contained in the fuel off-gas.

The gas-liquid separator 24 has a function to separate fuel off-gas, exhausted from the fuel cell 10, into a gas component and a liquid component. The separated gas component is supplied to the flow channel 20e. The separated liquid component is drained to the flow channel 20f via the exhaust and drain valve 25. Here, the liquid component is water produced by the electrochemical reaction in the fuel cell 10 and may contain inevitable impurities. The gas component is an unreacted fuel gas and may contain inevitable impurities.

The flow channel 20e (circulation channel) is a pipe that connects the gas-liquid separator 24 with the ejector 23. The flow channel 20e functions to feed the gas component (circulating gas), separated by the gas-liquid separator 24, to the ejector 23.

The exhaust and drain valve 25 is to control the drain of the liquid component separated by the gas-liquid separator 24. The exhaust and drain valve 25 may feed the liquid component to the flow channel 20f together with the gas component by using the pressure of the gas component as a driving force. The exhaust and drain valve 25 is controlled by the control unit 50.

The flow channel 20f (exhaust and drain flow channel) is a pipe connected to the exhaust and drain valve 25 and is a flow channel for draining the liquid component, separated by the gas-liquid separator 24, to outside the system. The flow channel 20f may be connected to the flow channel 30f. In this case, the liquid component drained is drained to outside the system via the flow channel 30f.

### Oxidant Gas Piping Section 30

The oxidant gas piping section 30 is to supply the cathode with oxidant gas. The oxidant gas piping section 30 includes an air filter 31, an air compressor 32, an inlet valve 33, and an outlet valve 34. The oxidant gas piping section 30 includes flow channels 30a, 30b, 30c, 30d, 30e, 30f that are pipes connected to these members. The flow channels 30a, 30b, 30c, 30d make up an oxidant gas supply flow channel. The flow channels 30e, 30f make up an oxidant gas exhaust flow channel. The oxidant gas piping section 30 includes an inlet oxidant gas temperature measurement device T1 and an oxidant gas pressure measurement device P2 at an oxidant gas inlet side of the fuel cell 10. The oxidant gas piping section 30 includes an outlet oxidant gas temperature measurement device T2 at an oxidant gas outlet side of the fuel cell 10. The oxidant gas piping section 30 may further include members generally included in an oxidant gas piping section.

The flow channel 30a is a pipe connected to the air filter 31. The flow channel 30a functions to feed oxidant gas to the air filter 31. When the oxidant gas is air, the flow channel 30a connects outside air with the air filter 31.

The air filter 31 functions to remove foreign matter contained in oxidant gas. The above air filter is known.

The flow channel 30b is a pipe that connects the air filter 31 with the air compressor 32. The flow channel 30b functions to feed oxidant gas, from which foreign matter is removed by the air filter 31, to the air compressor 32.

The air compressor 32 is an oxidant gas supply device that supplies oxidant gas to the fuel cell 10. The air compressor 32 is capable of controlling the amount of oxidant gas supplied to the fuel cell 10. The amount of oxidant gas supplied from the air compressor 32 is controlled by the control unit 50.

The flow channel 30c is a pipe that connects the air compressor 32 with the inlet valve 33. The flow channel 30c functions to feed oxidant gas, supplied from the air compressor 32, to the inlet valve 33.

The inlet oxidant gas temperature measurement device T1 and the oxidant gas pressure measurement device P2 are disposed in the flow channel 30c. The inlet oxidant gas temperature measurement device T1 measures the temperature of oxidant gas supplied to the fuel cell 10. The oxidant gas pressure measurement device P2 measures the pressure of oxidant gas supplied to the fuel cell 10. Measured results are transmitted to the control unit 50.

The inlet valve 33 functions to control the pressure and the amount of oxidant gas supplied from the air compressor 32. The inlet valve 33 is controlled by the control unit 50.

The flow channel 30d is a pipe that connects the inlet valve 33 with the fuel cell 10. The flow channel 30d functions to feed oxidant gas, regulated by the inlet valve 33, to the fuel cell 10.

The flow channel 30e is a pipe that connects the fuel cell 10 with the outlet valve 34. The flow channel 30e functions to feed oxidant gas (oxidant off-gas), exhausted from the fuel cell 10, to the outlet valve 34. Liquid water produced by the electrochemical reaction in the fuel cell 10 is contained in the oxidant off-gas.

The outlet valve 34 functions to control the exhaust of oxidant off-gas, exhausted from the fuel cell 10, to outside the system. The outlet valve 34 is controlled by the control unit 50.

The flow channel 30f is a pipe connected to the outlet valve 34. The flow channel 30f is a flow channel to exhaust oxidant off-gas, exhausted from the outlet valve 34, to outside the system. A flow channel 20f (exhaust and drain flow channel) may be connected in the middle of the flow channel 30f. The liquid component and the gas component, exhausted from the flow channel 20f (exhaust and drain flow channel), may be exhausted to outside the system together with oxidant off-gas.

The outlet oxidant gas temperature measurement device T2 is disposed in the flow channel 30f and measures the temperature of oxidant gas exhausted from the fuel cell 10. A measured result is transmitted to the control unit 50 as needed. During warm-up operation, the temperature of the fuel cell 10 is estimated based on the measured result of the outlet oxidant gas temperature measurement device T2. Therefore, during warm-up operation, the outlet oxidant gas temperature measurement device T2 is a fuel cell temperature measurement device.

### Refrigerant Piping Section 40

The refrigerant piping section 40 is to supply coolant gas (refrigerant) for cooling the fuel cell 10. The refrigerant piping section 40 includes an air filter 41 and a fan 42. The refrigerant piping section 40 includes flow channels 40a, 40b, 40c, 40d that are pipes connected to these members. The refrigerant piping section 40 further includes an inlet refrigerant temperature measurement device T3 at the refrigerant inlet side and an outlet refrigerant temperature measurement device T4 at the refrigerant outlet side of the fuel cell 10. The refrigerant piping section 40 may further include members generally included in a refrigerant piping section. The coolant gas is, for example, cooling air or the like.

The flow channel 40a is a pipe connected to the air filter 41. The flow channel 40a functions to feed coolant gas to the air filter 41. When the coolant gas is air, the flow channel 40a connects outside air with the air filter 41.

The air filter 41 functions to remove foreign matter contained in coolant gas supplied to the fuel cell 10. The above air filter is known.

The flow channel 40b is a pipe that connects the air filter 41 with the fuel cell 10. The flow channel 40b functions to feed coolant gas, from which foreign matter has been removed by the air filter 41, to the fuel cell 10.

The inlet refrigerant temperature measurement device T3 is disposed in the flow channel 40b and measures the temperature of refrigerant supplied to the fuel cell 10. A measured result is transmitted to the control unit 50 as needed.

The flow channel 40c is a pipe that connects the fuel cell 10 with the fan 42. The flow channel 40c functions to feed coolant gas, exhausted from the fuel cell 10, to the fan 42.

The outlet refrigerant temperature measurement device T4 is disposed in the flow channel 40c and measures the temperature of refrigerant exhausted from the fuel cell 10. A measured result is transmitted to the control unit 50 as needed. During normal operation, the temperature of the fuel cell 10 is estimated based on the measured result of the outlet refrigerant temperature measurement device T4. Therefore, during normal operation, the outlet refrigerant temperature measurement device T4 is a fuel cell temperature measurement device.

The fan 42 is a power source for feeding coolant gas through the refrigerant piping section 40 and is regarded as a refrigerant supply device that supplies coolant gas to the fuel cell 10. The amount of coolant gas supplied by the fan 42 is controlled by the control unit 50.

The flow channel 40d is a pipe connected to the fan 42. When the coolant gas is air, the flow channel 40d connects the fan 42 with outside air.

### Control Unit 50

The control unit 50 is a computer system that includes a CPU, a ROM, a RAM, an input and output interface, and the like. The control unit 50 is capable of controlling the sections of the fuel cell system 100.

The fuel cell system 100 uses coolant gas as refrigerant to cool the fuel cell 10. In other words, the fuel cell system 100 is an air cooling type.

After startup of the fuel cell system 100, when the temperature of the fuel cell 10 is lower than a target temperature (at the time of low-temperature startup), the temperature of the fuel cell 10 needs to be quickly increased to the target temperature to increase the electrical efficiency of the fuel cell 10. This is called a warm-up operation. In warm-up operation, it is conceivable that electric power is generated while refrigerant is not supplied to the fuel cell 10 at all to increase the rate of increase in the temperature of the fuel cell 10. However, if refrigerant is not supplied at all, heat spots occur in the fuel cell 10, so the degradation of the fuel cell 10 can be facilitated.

On the other hand, when the amount of refrigerant supplied is adjusted as described in JP 2015-216084 A and JP 2010-186599 A, occurrence of heat spots is suppressed to some extent. However, a valve or the like needs to be installed in a refrigerant flow channel to adjust the amount of refrigerant supplied, which may lead to a complicated system and a cost increase. In the case of an air cooling type, the heat capacity of coolant gas is small, so heat spots more easily occur.

In the fuel cell system 100, a warm-up operation at low-temperature startup is performed by stopping supply of refrigerant and controlling the amount of oxidant gas supplied. In other words, in the fuel cell system 100, when the temperature of the fuel cell 10 is lower than the target temperature, the control unit 50 generates electric power with the fuel cell 10 while cooling the fuel cell 10 with oxidant gas by stopping supply of coolant gas and controlling the amount of oxidant gas supplied. Thus, the control unit 50 performs a warm-up operation in which the temperature of the fuel cell 10 is increased to the target temperature.

Thus, during warm-up operation, the warm-up operation is quickly completed while occurrence of heat spots is suppressed with a simple configuration without installing an additional valve or the like. By quickly completing a warm-up operation, the electrical efficiency of the fuel cell 10 is improved. During warm-up operation, flooding is suppressed by controlling the amount of oxidant gas supplied.

The amount of oxidant gas to be supplied during warm-up operation may be controlled as needed in accordance with the temperature and the rate of increase in the temperature of the fuel cell 10. For example, the amount of oxidant gas supplied may be reduced or may be increased as compared to during normal operation. The amount of oxidant gas supplied may be increased from the viewpoint of cooling the fuel cell 10. The amount of oxidant gas supplied may be controlled based on the temperature of oxidant gas (a measured result of the inlet oxidant gas temperature measurement device T1). The amount of oxidant gas supplied may be controlled based on the results of experiment and simulation in advance such that heat spots are suppressed.

For example, the amount of oxidant gas supplied during warm-up operation may be greater than or equal to a half and less than or equal to ten times the amount of oxidant gas supplied during normal operation or may be twice or more and less than or equal ten times. Thus, heat spots are further suppressed. The amount of fuel gas supplied during warm-up operation may be greater than or equal to a half and less than or equal to ten times the amount of oxidant gas supplied during normal operation or may be twice or more and less than or equal ten times. Thus, the temperature of the fuel cell 10 is quickly increased.

The temperature of the fuel cell 10 is usually estimated from the measured result of the outlet refrigerant temperature measurement device T4. However, since supply of refrigerant is stopped during warm-up operation, the temperature of the fuel cell 10 cannot be estimated based on the measured result of the outlet refrigerant temperature measurement device T4. During warm-up operation, the temperature of the fuel cell 10 is estimated from the measured result of the outlet oxidant gas temperature measurement device T2. The rate of increase in the temperature of the fuel cell 10 is calculated from a temporal change in the estimated temperature of the fuel cell 10. The target temperature of the fuel cell 10 is a temperature suitable for power generation of the fuel cell 10 and is set as needed in accordance with the configuration of the fuel cell 10.

A warm-up operation may be controlled by using not only a measured result of the outlet refrigerant temperature measurement device T4 but also measured results of other measurement devices. For example, to control the amount of electric power generated by the fuel cell 10, the measured result of the fuel gas pressure measurement device P1 and the measured result of the oxidant gas pressure measurement device P2 may be used.

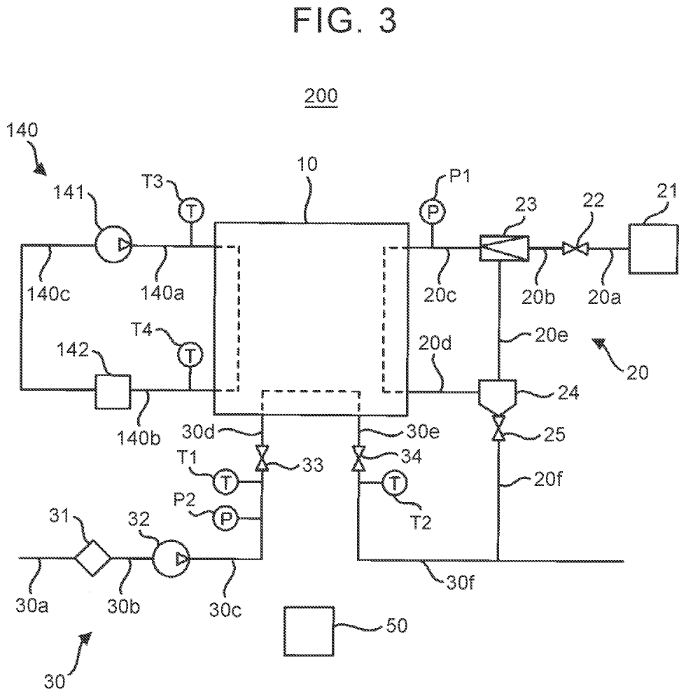

FIG. 2 is an example of a flowchart for determining whether to perform a warm-up operation. As shown in FIG. 2, for example, at startup, it is determined whether the temperature of the fuel cell 10 is lower than the target temperature. When the temperature of the fuel cell 10 is lower than the target temperature, a warm-up operation is performed. The above-described control method is adopted for warm-up operation. After that, when the temperature of the fuel cell 10 is higher than or equal to the target temperature as a result of warm-up operation, the warm-up operation is stopped, and the normal operation is performed. A normal operation is an operation using coolant gas.

The temperature of the fuel cell 10 is quickly increased to the target temperature by performing a warm-up operation with the above flowchart.

### Fuel Cell System 200

In the fuel cell system 100, a mode in which coolant gas is used as refrigerant has been described. Refrigerant allowed to be used in the fuel cell system according to the aspect of the disclosure is not limited thereto, and coolant may be used. Even in the mode (water cooling type) using coolant, the advantageous effects of the disclosure are obtained.

A fuel cell system 200 that is an embodiment using coolant as refrigerant will be described below. FIG. 3 is a block diagram of the fuel cell system 200.

The fuel cell system 200 differs from the fuel cell system 100 in that the refrigerant piping section 40 is replaced with a refrigerant piping section 140. Therefore, the other configuration is the same, so the description is omitted.

### Refrigerant Piping Section 140

The refrigerant piping section 140 is to supply coolant (refrigerant) for cooling the fuel cell 10. As shown in FIG. 3, the refrigerant piping section 140 is used by circulating coolant. The refrigerant piping section 140 includes a pump 141 and a radiator 142. The refrigerant piping section 140 includes flow channels 140a, 140b, 140c that are pipes connected to these members. As in the case of the fuel cell system 100, the refrigerant piping section 140 further includes the inlet refrigerant temperature measurement device T3 at the refrigerant inlet side and the outlet refrigerant temperature measurement device T4 at the refrigerant outlet side of the fuel cell 10. The refrigerant piping section 140 may further include members generally included in a refrigerant piping section.

The pump 141 is a power source for coolant to circulate through the refrigerant piping section 140 and is regarded as a refrigerant supply device that supplies coolant to the fuel cell 10.

The flow channel 140a is a pipe connected to the pump 141 and the fuel cell 10 and is to feed coolant supplied from the pump 141.

The flow channel 140b is a pipe connected to the fuel cell 10 and the radiator 142 and is to feed coolant drained from the fuel cell 10.

The radiator 142 is to cool coolant by exchanging heat between coolant and outside air.

The flow channel 140c is a pipe connected to the radiator 142 and the pump 141 and is to feed coolant cooled by the radiator 142.

The fuel cell system according to the aspect of the disclosure has been described by using the fuel cell systems 100, 200 that are embodiments. With the fuel cell system according to the aspect of the disclosure, heat spots are suppressed while a warm-up operation is performed with a simple configuration.

What is claimed is:

1. A fuel cell system comprising:
a fuel cell configured to generate electric power when supplied with fuel gas and oxidant gas;
a fuel gas supply device configured to supply the fuel gas to the fuel cell;
an oxidant gas supply device configured to supply the oxidant gas to the fuel cell;
a refrigerant supply device configured to supply refrigerant to the fuel cell;
a fuel cell temperature measurement device configured to measure a temperature of the fuel cell; and
a control unit, wherein
the control unit is configured to, when the temperature of the fuel cell is lower than a target temperature, perform a warm-up operation to increase the temperature of the fuel cell to the target temperature by generating the electric power with the fuel cell while cooling the fuel cell with the oxidant gas by stopping supply of the refrigerant and controlling an amount of the oxidant gas supplied.

2. The fuel cell system according to claim 1, wherein the refrigerant is a coolant gas.

3. The fuel cell system according to claim 1, wherein the control unit is configured to control the oxidant gas supply device such that the amount of the oxidant gas supplied during the warm-up operation is greater than or equal to a half and less than or equal to ten times the amount of the oxidant gas supplied during normal operation.

4. The fuel cell system according to claim 1, wherein the control unit is configured to control the fuel gas supply device such that an amount of the fuel gas supplied during the warm-up operation is greater than or equal to a half and less than or equal to ten times the amount of the fuel gas supplied during normal operation.
